(19) United States
(12) Patent Application Publication
(10) Pub. No.: US 2016/0271572 A1
(43) Pub. Date: Sep. 22, 2016

(54) A NETWORK CONNECTED WINE DECANTER APPLIANCE FOR OXIDIZING WINE

(71) Applicant: TOP ELECTRIC APPLIANCES INDUSTRIAL LTD., Guangzhou, Guangdong (CN)

(72) Inventor: Weizhong LI, Guangzhou, Guangdong (CN)

(73) Assignee: Top Electric Appliances Industrial Ltd., Guangzhou, Guangdong (CN)

(21) Appl. No.: 14/436,419

(22) PCT Filed: Jul. 2, 2014
(86) PCT No.: PCT/CN2014/081497

§ 371 Date: Apr. 16, 2015

(30) Foreign Application Priority Data
Jun. 6, 2014 (CN) PCT/CN1014/079419
Jun. 6, 2014 (CN) PCT/CN2014/079420
Jun. 6, 2014 (CN) PCT/CN2014/079421

(51) Int. Cl. B01F 3/04; B01D 53/047; B01F 15/00; C12G 1/00; C12H 1/12

(52) U.S. Cl. CPC B01F 3/04794; C12G 1/00; C12H 1/12; B01F 15/00305; B01D 53/047; B01F 2003/04879; B01F 2215/0072; B01D 2253/108; B01D 2256/12

(57) ABSTRACT

The invention provides a method and a wine decanter appliance for automatically oxidizing wine. The wine decanter appliance comprises means for delivering a flow of oxygen laden gas to a quantity of wine to oxidize said wine, a communications module connecting said wine decanter appliance to a communications network, a memory storing an application program, and a processor configured to execute said application program to enable said wine decanter appliance to exchange information through said communications network with any one or any combination of: a server; a database; a network connected device, another wine decanter appliance or a group of other wine decanter appliances. The processor is configured to control said wine decanter appliance to oxidize the wine based on information received over said network as a consequence of said exchange of information.

### TECHNICAL FIELD

The invention relates to a wine decanter for oxidizing wine to improve its readiness for drinking.

### BACKGROUND ART

Some wines need to be allowed to breathe for a period of time prior to drinking to reduce or remove any malodorous vapors, to improve the smoothness of the taste of the wine, and to improve the bouquet of the wine. The process of allowing a wine to breathe normally comprises allowing the wine to be exposed to air for a period of time. Oxygen in the air acts on the wine to oxidize it thereby releasing aromas and flavors in the wine.

Breathing of wine normally concerns red wines, although some white wines also benefit from this process. Consumable products such as wine are complex products which vary widely in how they are best processed. The degree to which a wine should be allowed to breathe, if at all, varies according to many factors including the type of wine, the age of the wine, the type of grapes used to make the wine, the temperature of the wine, the ambient temperature, quantity of wine, year of production, brand, etc. In effect, those wines that do benefit from being oxidized each have a unique set of requirements for oxidation to successfully improve the taste of the wine prior to drinking.

The possible permutations of the multiple factors leads to what may be considered as an overwhelming selection of competing or alternative control options or sets of control parameters for a user of the wine decanter appliance to select from. Another problem is that users will often only learn about different control parameter options though use of the appliance by trial and error.

### DISCLOSURE OF INVENTION

### Technical Problem

An object of the invention is to mitigate or obviate to some degree one or more problems associated with known wine decanters for oxidizing wine.

The above object is met by the combination of features of the main claims; the sub-claims disclose further advantageous embodiments of the invention.

Another object of the invention is to provide a user of a wine decanter appliance with access to knowledge from any of producers, suppliers, distributors or sellers of wine.

Another object of the invention is to provide a user of a wine decanter appliance with access to knowledge from other users of similar or the same wine decanter appliances.

Another object of the invention is to provide a wine decanter appliance for automatically oxidizing a wine based on control characteristics or parameters accessed through a communications network to which the wine decanter appliance is connected.

One skilled in the art will derive from the following description other objects of the invention. Therefore, the foregoing statements of object are not exhaustive and serve merely to illustrate some of the many objects of the present invention.

### SOLUTION TO PROBLEM

### Technical Solution

In a first main aspect, the invention provides a wine decanter appliance for oxidizing wine, comprising: means for delivering a flow of oxygen laden gas to a quantity of wine to oxidize said wine; a communications module connecting said wine decanter appliance to a communications network; a memory storing an application program; a processor configured to execute said application program to enable said wine decanter appliance to exchange information through said communications network with any one or any combination of: a server; a database; a network connected device, another wine decanter appliance or a group of other wine decanter appliances; wherein said processor is configured to control said wine decanter appliance to oxidize the wine based on information received over said network as a consequence of said exchange of information.

In a second main aspect, the invention provides a method of oxidizing wine in a network connected wine decanter appliance comprising the steps of: connecting said wine decanter appliance to a communications network; exchanging information through said communications network with any one or any combination of: a server; a database; a network connected device, another wine decanter appliance or a group of other wine decanter appliances for oxidizing wine; controlling said wine decanter appliance to oxidize the wine based on information received over said network as a consequence of said exchange of information.

In a third main aspect, the invention provides a computer readable medium storing machine readable instructions which, when implemented on a processor of a network connected wine decanter appliance, implements the steps of the method of the second main aspect of the invention.

The summary of the invention does not necessarily disclose all the features essential for defining the invention; the invention may reside in a sub-combination of the disclosed features.

### BRIEF DESCRIPTION OF DRAWINGS

### Description of Drawings

The foregoing and further features of the present invention will be apparent from the following description of preferred embodiments which are provided by way of example only in connection with the accompanying figures, of which:

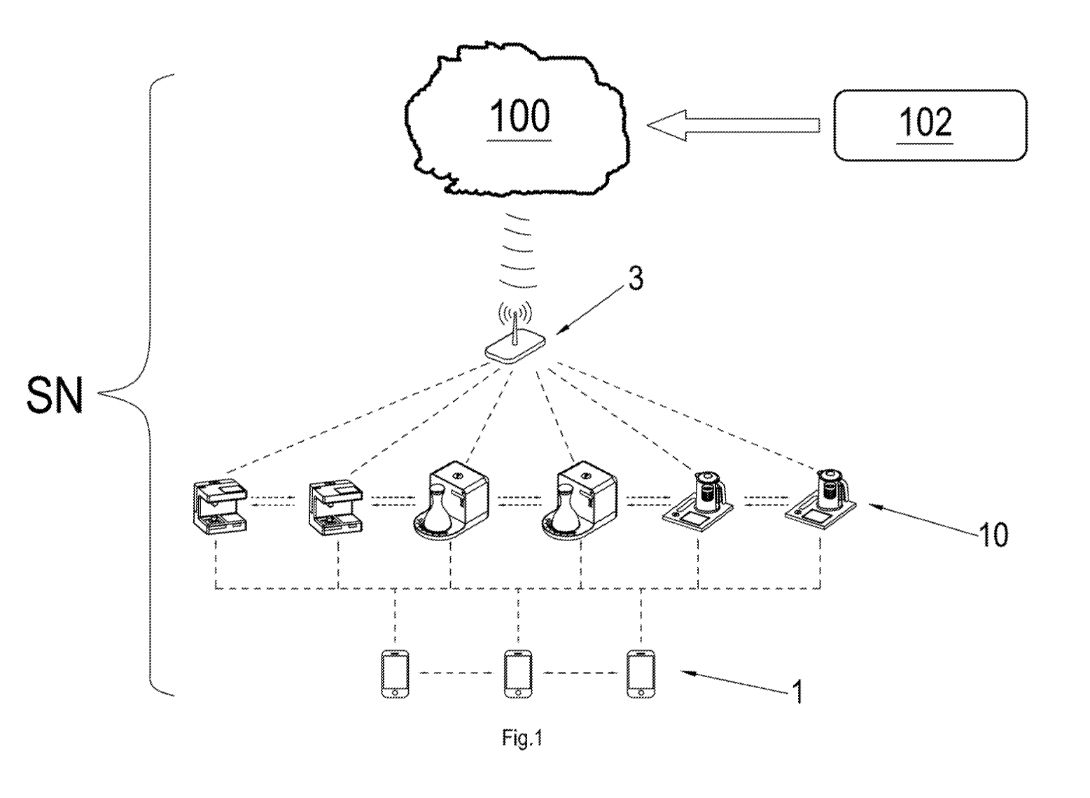

FIG. 1 is a block schematic diagram of a social network of domestic appliances for processing consumable products;

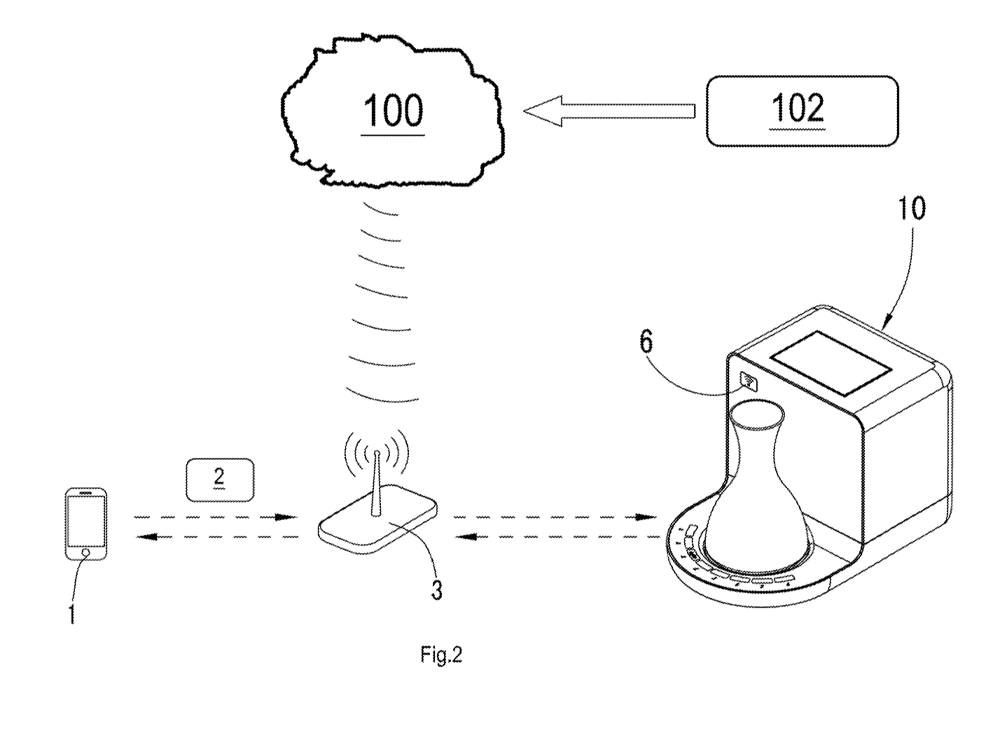

FIG. 2 is a block schematic diagram of a network connected wine decanter appliance according to the invention;

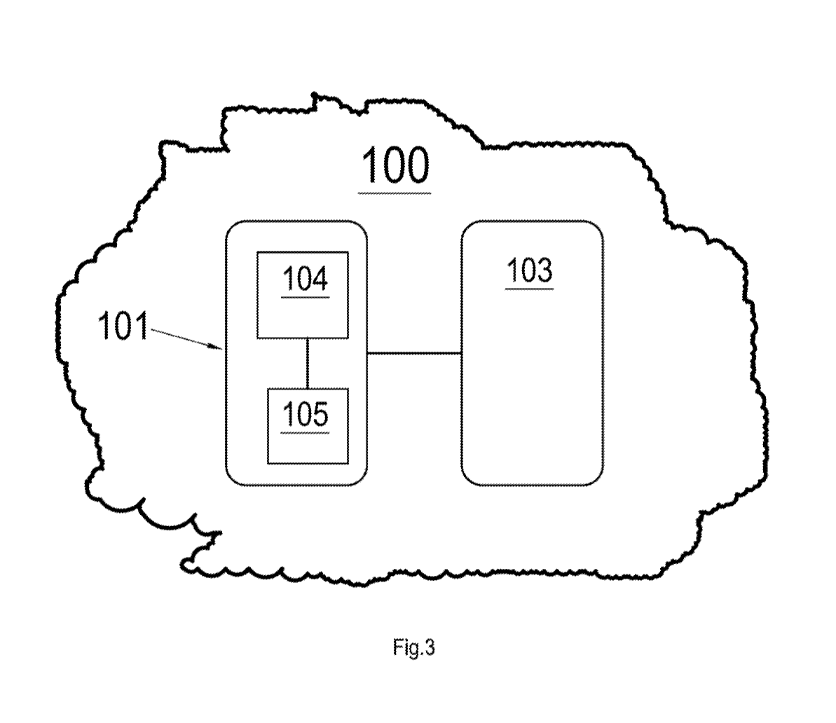

FIG. 3 is a schematic diagram of a network to which the wine decanter appliance of FIG. 2 is connected:

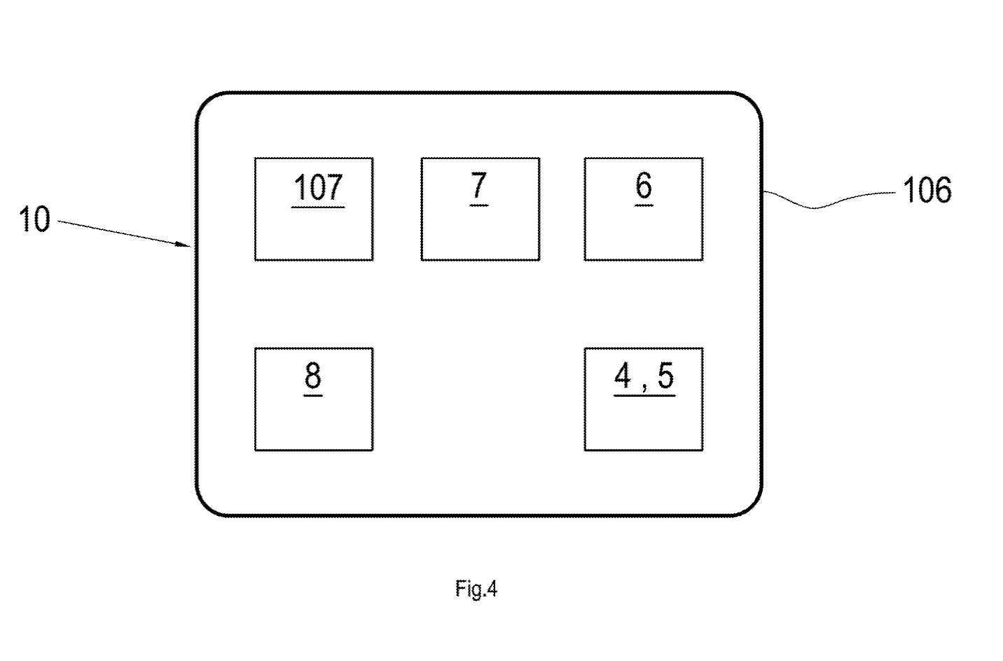

FIG. 4 is a block schematic diagram of a wine decanter appliance according to the invention;

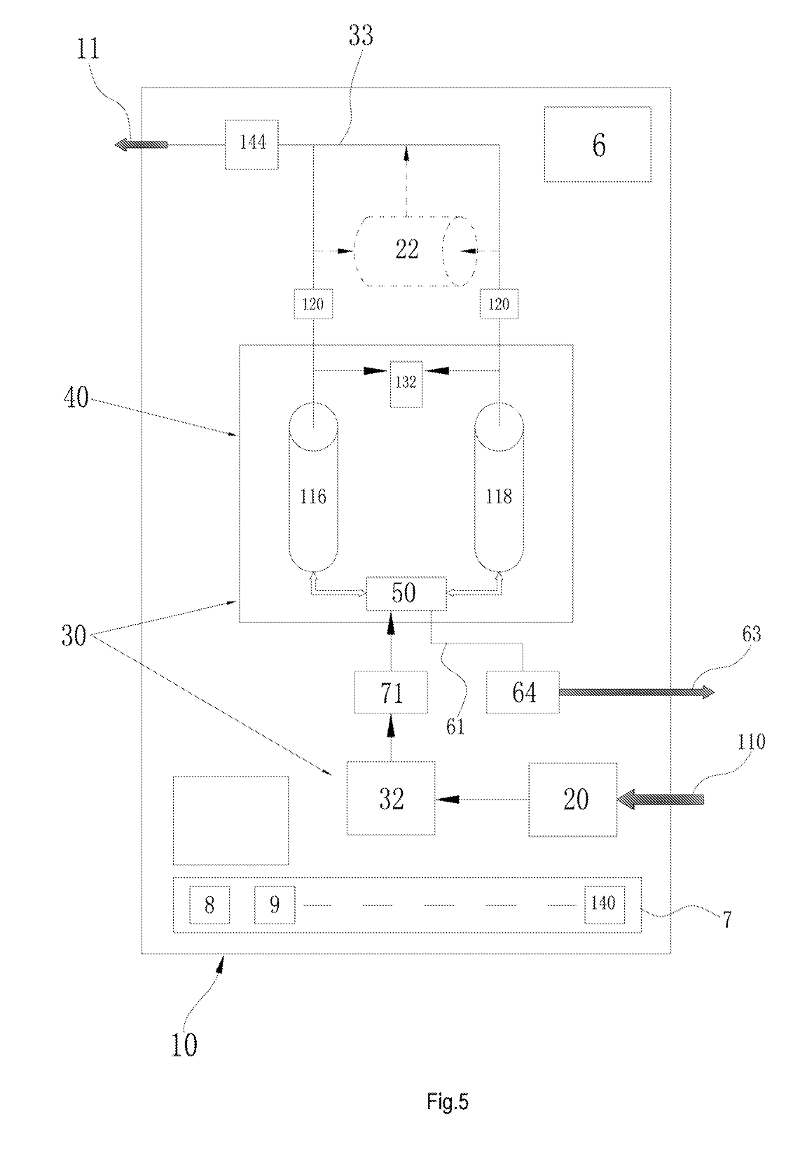

FIG. 5 is a more detailed block schematic block diagram of a wine decanter appliance according to the invention;

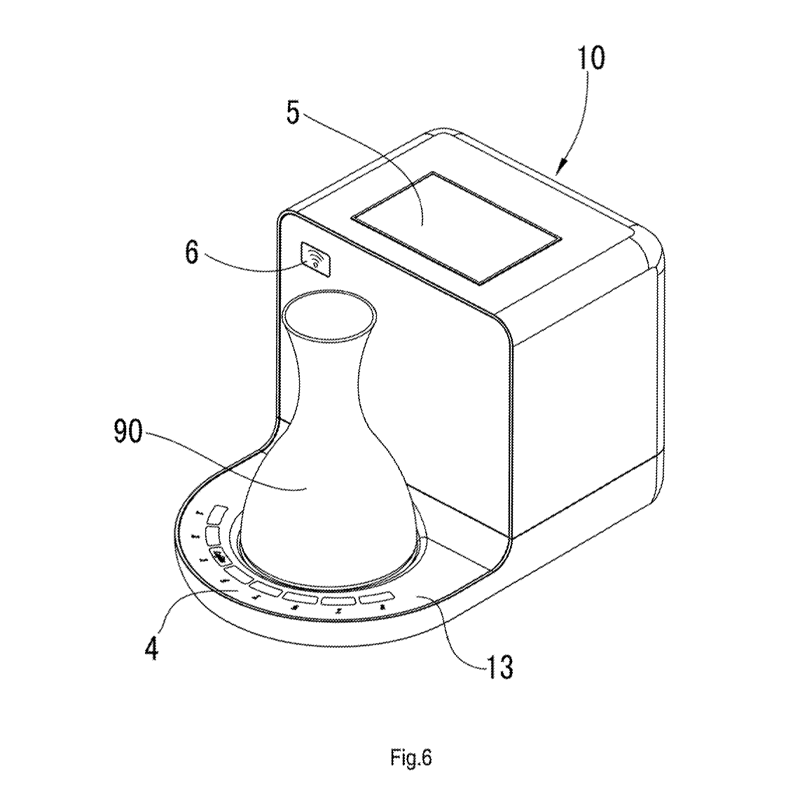

FIG. 6 is a perspective front view of a wine decanter appliance according to the invention;

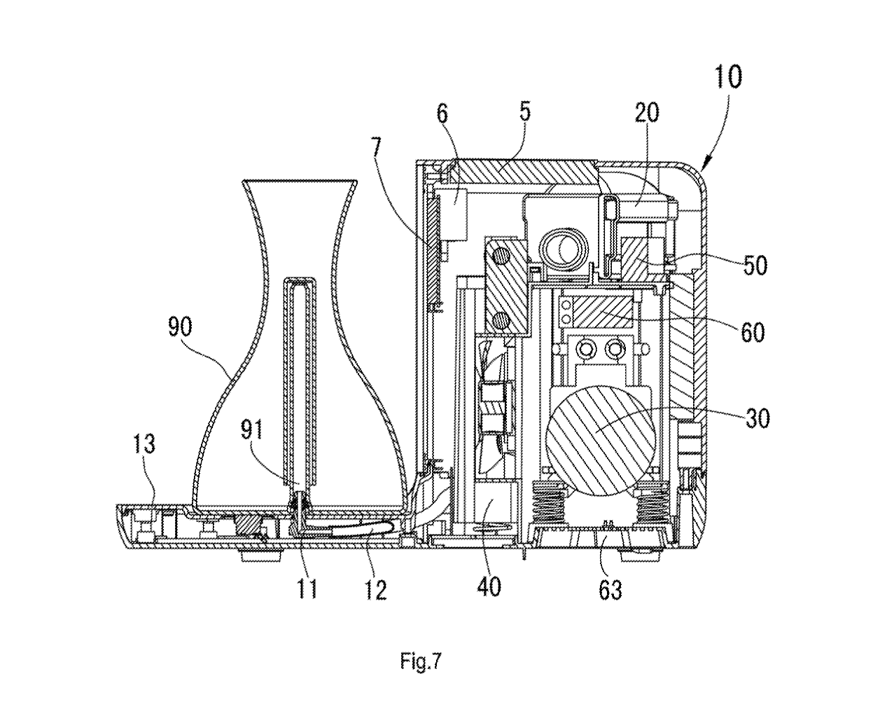

FIG. 7 is a first side sectional view of the wine decanter appliance of FIG. 6; and

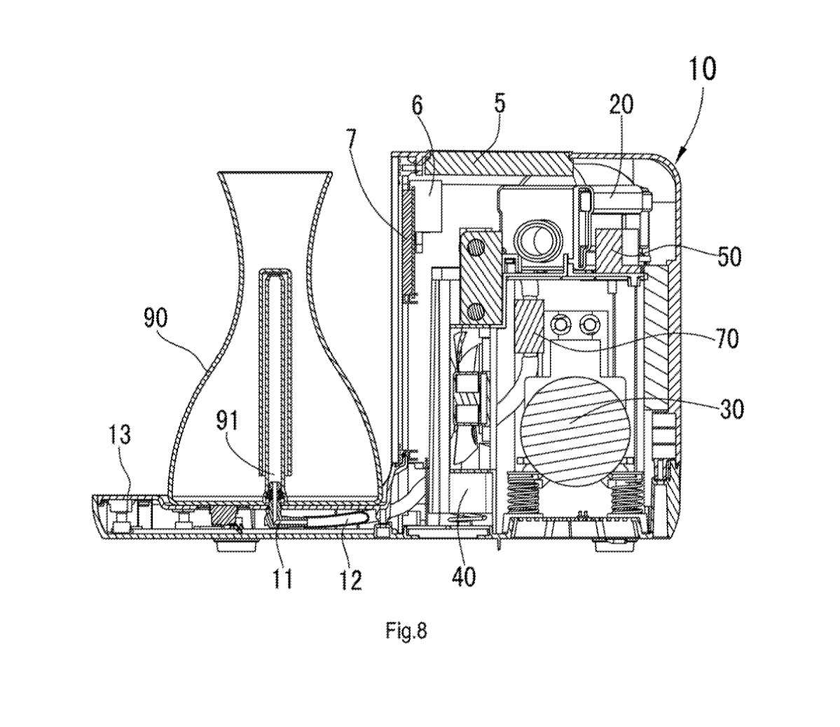

FIG. 8 is a second side sectional view of the wine decanter appliance of FIG. 6.

### MODE FOR THE INVENTION

### Mode for Invention

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

It should be understood that the elements shown in the FIGS, may be implemented in various forms of hardware, software or combinations thereof. Preferably, these elements are implemented in a combination of hardware and software on one or more appropriately programmed general-purpose devices, which may include a processor, memory and input/output interfaces.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

Referring to FIG. 1, shown is a block schematic diagram of a social network ‘SN’ of domestic appliances 10 for processing consumable products including wine. The social network SN comprises a plurality of appliances 10 connected to a communications network 100 through a wireless router 3. Whilst FIG. 1 shows all of the appliances 10 connected through the same wireless router 3, it will be understood that the appliances 10 may be separately connected to the network 100 through their own dedicated or shared wireless routers 3 or through any other suitable wired or wireless network connection means such as Ethernet cables.

Whilst the communications network 100 preferably comprises a CLOUD network, it will be understood that the network 100 may comprise any communications network, private and/or public, which enables network enabled appliances 10 to be able to communicate through the network 100 with each other, with network based devices and with other devices connected to the network 100.

It will also be understood that, in some embodiments, only appliances 10 adapted for oxidizing wine will be authorized to connect to the network 100.

Each appliance 10 in the social network SN is configured to execute a social network application 2 which may be hosted by a server 101 (FIG. 3) whereby users of the appliances can exchange social media messages with each other through the network 100.

A plurality of third party entity devices 102 are connected to the network 100. Each third party entity device 102 is preferably also a network enabled appliance 10, but could comprise any network enabled device 102 which allows data to be uploaded to the server 101. Each third party entity preferably comprises a producer of the consumable product, but may comprise any of a supplier, distributor or seller of the product.

The appliances 10 may also be enabled to communicate wirelessly with handheld electronic processing devices 1 such as smart phones or tablet computers or even to communicate with personal computers (PCs) or the like (not shown) to receive and/or share other parameters or information relating to the consumable product and to execute applications 2.

Referring to FIG. 2, shown is a social network 1 based on a plurality of wine decanter appliances 10 for oxidizing wine. Whilst only one wine decanter appliance 10 is shown connected to the communication network 100, it will be understood that a plurality of such appliances 10 may be connected to the network 100 and that said appliances 10 may be located in geographically diverse regions as afforded by the coverage of the network 100. It will also be understood that other types of appliances as depicted in FIG. 1 may also be connected to the network 100, although, preferably, only wine decanter appliances 10 of a same or similar type, i.e. from a same manufacturer of wine decanter appliances, are authorized to connect to the network 100 to thereby restrict the social network to such appliances 10.

As is best seen in FIG. 3, the network 100 has a network based server 101 and a database 103 under control of the server 101. The server 101 comprises at least one processor 104 and at least one memory 105. The server memory 105 stores machine code which, when executed by the processor 104, implements the server based methods of the invention as described herein. Whilst the database 103 is shown as a separate network based device to the server 101, it will be understood that the server 101 may host the database 103 in some embodiments. It will also be understood that the network 100 may include, in some embodiments, a plurality of network connected servers 101 and databases 103 and that these may be located at geographically diverse locations. In some embodiments, the plurality of servers 101 and databases 103 may be associated with respective third party entities.

The communications network 100 may comprise or include the public internet or may comprise a virtual private network (VPN) hosted by public communication networks such as the internet.

Access to the network 100 may, in some embodiments, be restricted to only networked enabled wine decanter appliances 10, 102 as herein described. Access to the network 100 may also be restricted by means of authenticating appliances 10, 102 attempting to connect to the server 101. Consequently, in some embodiments, the community of devices 10, 102 which can connect to the network 100 is restricted to wine decanter appliances which have embedded therein suitable authentication software and suitable authentication codes to provide access to the restricted access network 100). In this way, the network 100 is restricted to a community of users of authorized wine decanter appliances 10, 102 which are adapted to automatically oxidize wine.

FIG. 4 is a schematic block diagram of a wine decanter appliance 10. The wine decanter appliance 10 comprises a housing 106 containing means for delivering a flow of oxygen laden gas into a quantity of wine 107; a central control unit 7 for controlling the gas delivery means 107 to oxidize the wine according to one or more control parameters, a communications module 6 connecting said appliance 10 to the communications network 100, a memory or data storage module 8 storing an application program, and at least one input interface 4, 5 which preferably includes a touch screen 5. The processor 7 is configured to execute said application program to enable said appliance 10 to exchange information through said communications network 100 with any one or any combination of the network server 101, the network database 103, or another wine decanter appliance 10, 102.

Referring again to FIG. 2, the communications module 6 of the wine decanter appliance 10 may be WiFi™ enabled to allow the wine decanter appliance 10 to connect to the network 100 via a wireless connection through the wireless muter 3, but it will be understood that the wine decanter appliance 10 may connect to the network 100 through any suitable wireless or wired means including an Ethernet connection.

Referring to FIGS. 5 to 8, the present invention provides a network connected appliance 10 for automatically oxidizing wine by passing oxygen into the wine through the gas delivery means 107. The gas delivery means 107 preferably comprises an air processing system 30 which includes an oxygen concentrator apparatus 40 which takes in atmospheric air and processes it to concentrate its oxygen content to as much as or even higher than 90% oxygen by volume, although lower levels of oxygen concentration such as 30%, 50% or 70% may suffice or be preferred for some wines. The oxygen concentrator apparatus 40 may be operated to provide oxygen concentrated air having an adjustable percentage of oxygen by volume of at least 30%, but in some embodiments, it may be adjustable above at least 50%, about at least 70% or above at least 90%. The appliance 10 comprises a controller or central control unit 7 for automatically controlling one or more parameters of the wine oxidation process. Parameters may include a time period for delivery of oxygen concentrated air to the wine where the time period is predetermined in accordance with one or more characteristics or qualities of the wine and/or in response to user inputs to the appliance 10. Other parameters may include a concentration level of oxygen in the processed air and a flow rate, e.g. a volume flow rate, of processed air being delivered to the wine. It is implicit therefore that the appliance 10 may include a sensor or the like to detect an oxygen concentration level in the processed air and a flow meter for measuring flow rates of processed air or gas.

FIG. 5 shows a more detailed block schematic diagram of the wine decanter appliance 10 for automatically oxidizing wine in accordance with the invention. The appliance 10 has an air inlet port 110 for drawing in atmospheric air to the oxygen concentrator apparatus 40 of the air processing apparatus 30. The appliance 10 includes one or more outlet ports 11, one of which is adapted for delivering oxygen concentrated air under pressure to wine contained in a receptacle or container 90 via the receptacle's inlet port 91. The receptacle 90 rests on a base plate 13 of the appliance 10. An air filter 20 is provided to filter drawn in atmospheric air to rid it of debris, dust and maybe even particulates before said air reaches the oxygen concentrator apparatus 40. At least one compressor or pump 32 is provided to pump filtered air into the oxygen concentrator 40. Oxygen concentrated air exiting the oxygen concentrator apparatus 40 under pressure is delivered to the outlet port 11 via a conduit 12 (FIG. 6), although in some embodiments, a reservoir tank 22 (shown in broken outline in FIG. 1) may be provided as a means of temporarily storing pressurized oxygen enriched/concentrated air, or even storing processed air for longer periods of time, for subsequent use. In some embodiments, the appliance may be arranged to deliver filtered atmospheric air to wine in which case the oxygen concentrating apparatus 40 may not be required.

The appliance 10 has a computer implemented control unit 7. The control unit 7 is adapted to control operation of all functions of the appliance 10. The control unit 7 includes at least one processor and at least one a memory or data storage module 8, but may include a number of other processors, memories and other modules 140 as required for implementing various aspects of the present invention as will be described hereinbelow.

A power supply of the appliance 10 may comprise a mains power supply, but, in some embodiments, this is replaced by a rechargeable battery power supply which may be removable for recharging on an external charger module (not shown) or the battery power supply may be charged in situ. In yet further embodiments, the appliance is provided with both a mains power supply and a rechargeable battery power supply and, in this case, the control unit 7 may include a charger circuit for charging the battery power supply from the mains power supply. Providing the appliance 10 with a rechargeable battery power supply enables the appliance 10 to be used in environments such as at a service point or patron's table in a restaurant where connecting the appliance 10 to a mains power supply may not be convenient.

A communications module 6 is provided as one means of enabling the appliance 10 to connect to a network (FIG. 2). The communications module 6 preferably enables the appliance to wirelessly connect to the network, e.g. by Wi-Fi™, Bluetooth™ or the like. The appliance 10 may be arranged to be controlled by another device such as a smart phone or tablet computer by way of remote control using a Bluetooth™ or other short range wireless communication protocol. Alternatively, or in addition, the appliance 10 may include a suitable network enabled port to connect the appliance 10 by cable to a router 3 or the like. The network enabled port may be provided by the communications module 6 (as shown in FIG. 5) or by the controller 7.

The oxygen concentrator apparatus 40 may comprise any suitable molecular sieve apparatus for increasing the concentration of oxygen in atmospheric air, but preferably comprises a zeolite based oxygen concentrator apparatus 40 operating on a pressure swing adsorption process. As such, the oxygen concentrator apparatus 40 includes first and second zeolite containing vessels 116, 118. The oxygen concentrator apparatus 40 is adapted to remove some or most gases, e.g. nitrogen, other than oxygen from atmospheric air to thereby provide oxygen concentrated or oxygen enriched air.

In operation of the oxygen concentrator apparatus 40, at high pressure, nitrogen sticks to the surface of the zeolite. Because the zeolite is extremely porous, it has a very large surface area and can adsorb large volumes of gas. At low pressure the nitrogen is released. The oxygen concentrator 40 includes a swing valve 50, such as a magnetically operated valve, which switches to direct pressurized filtered air into the first and second zeolite vessels 116, 118 in turn on a half-cycle basis.

The oxygen concentration process is cyclical with each cycle having two halves of equal duration. The cycle can be explained with respect to the first vessel 116 as follows. In the first half of a cycle the first vessel 116 receives air from the compressor 32. The first half cycle lasts typically about 3 seconds, but may last longer. During that time the pressure in the first vessel 116 rises from atmospheric pressure to a few times normal atmospheric pressure (typically 20 psi/138 kPa gauge, or 2.36 atmospheres absolute) and the zeolite material becomes saturated with nitrogen so that pumping in additional air would begin to reduce the oxygen concentration. Part way through the first half of the cycle the gas in the first vessel 116 becomes close to pure oxygen, although small amounts of argon, CO₂, water vapor, radon and other minor atmospheric components remain. The magnetic swing valve 50 is opened to allow gas to start flowing to a pressure equalizing reservoir 132. At the end of the first half of the cycle there is another valve position change so that the air from the compressor 32 is directed to the second vessel 118. As oxygen concentrated air (almost pure oxygen) in the first vessel 116 flows to the reservoir 132, the pressure in the first vessel 116 drops, and the nitrogen adsorbed on its zeolite begins to be released back into the gas, so that the oxygen concentration begins to drop. Part way through the second half of the cycle there is another valve change whereby the gas still in the first vessel 116 is vented to atmosphere through a respective vent 63 via the valve 50 and a pump passage 61 of a pump 64 of a vacuum system which maintains a negative pressure in the oxygen concentrator apparatus 40. The swing adsorption process preferably keeps the concentration of oxygen in the pressure equalizing reservoir 132 from falling below about 90%. The pressure in the pathway 33 delivering oxygen concentrated air from the equalizing reservoir 132 to the outlet 11 is kept relatively steady by a pressure reducing valve 144. Outlet conduits from the first and second vessels 116, 118 may each include a one-way valve 120 to prevent gas flowing back into the oxygen concentrator apparatus 40.

In some embodiments, the oxygen concentrator apparatus 40 may be operated to provide oxygen concentrated air having at least 50% by volume of oxygen or at least 70% by volume of oxygen, but it is preferably operated to provide at least 90% by volume of oxygen.

In one embodiment, the appliance 10 may be controlled to vent initially processed air to atmosphere before then delivering oxygen concentrated air under pressure to a beverage via the outlet port 11. The appliance 10 may be controlled to vent initially processed air to atmosphere until it is detected that the oxygen concentration in the processed air has reached a predetermined minimum threshold level after which said processed air comprising oxygen concentrated air is conveyed to the appliance outlet port 11. An oxygen level detector may be provided in the appliance 10 for this purpose. However, it is preferred that initially processed air is vented to atmosphere for a set period of time to enable the oxygen concentration in the processed air to reach a predetermined minimum threshold level as this requires only a timing control by the control unit 7 and does not require any oxygen level detection means.

A drying device 70 may be provided to dry the oxygen concentrated air. The appliance may also include a heater unit 71.

As already described, the wine decanter appliance 10 comprises a housing 106 accommodating a wireless communication module 6 for enabling the wine decanter appliance 10 to connect to the network 100, a plurality of input devices or interfaces including a user interface 4 and a touch screen 5. The plurality of user interfaces may include a camera module, a face recognition module, a voice recognition module, and a bar code or QR code scanning module. The input modules enable a user to manually or automatically input information into the wine decanter appliance 10 for various functions including as content of messages to be shared with other network connected devices 10, 102 including other wine decanter appliances 10 whereby users of said appliances 10 can share information. For example, the QR scanning code module may be adapted to read bar codes, QR codes or any other form of printed code on the packaging, label or the like of a bottle of wine in order to obtain information concerning the identity of the product and one or more of its characteristics as hereinafter described. The voice recognition module may have the dual functions of enabling a user to enter spoken information concerning a wine product into the appliance 10 and to recognize a specific user's voice in order that any use of the appliance is recorded for that user. In this way, the appliance can offer an individual user experience to each user even though a plurality of users utilize the same appliance. The camera module may be adapted to interoperate with the face recognition module to recognize individual users of the appliance 10 as well as to recognize information, written or pictorial, or other indicia which enable the appliance 10, either by itself or in cooperation with the server 101, to derive information about the identity of a wine product and one or more of its characteristics.

The wine decanter appliance 10 also includes a processor in the form of the central control unit 7, at least one memory in the form of the data storage module 8 and an information interaction module 9 which is specifically tasked with processing information received at any of the input devices or interfaces relating to the wine product a user wishes to process on the appliance 10 or wishes to receive more information about for enhancing processing of that product in the appliance 10. Information acquired by the appliance 10 may be processed by the information interaction module 9 in communication with similar such modules 9 of other network connected wine decanter appliances 10.

One method of the invention enables third party entities 102 such as producers, suppliers, distributors and sellers of wine products to upload information about the wine products to the server 101 such that this information is accessible by users of as the wine decanter appliances 10. In order to make the information accessible to users of wine decanter appliances 10, the information is stored by the server 101 in the database 103 in association with an identity of the wine product and/or one or more characteristics of the wine product. For example, an identity of the wine product may comprise its brand name and/or the name of its manufacturer, distributor, supplier or seller. It is necessary that the identity is unique to avoid conflict between product information from different third party entities. In some embodiments, the server may be enabled to associate a unique identifier with each third party entity authorized to upload data to the network 100

The one or more characteristics of the wine product may comprise one or more of its wine type, its grape type, its quality, and/or its year or date of production.

It is envisaged that each third party entity will upload a preferred or optimized set of control parameters for each permutation of its wine products' identities and/or characteristics where said sets of preferred or optimized control parameters are preferred or optimized specifically for the wine decanter appliance 10. As such, it is envisaged that the third party entity will be supplied with at least one such wine decanter appliance 10 to enable said third party entity to experiment with its wine products to derive the preferred or optimized sets of control parameters. This device may also be used by the third party entity to upload data to the server 101.

It will be understood that the number of preferred or optimized sets of control parameters received by the server 101 will grow enormously given the range of permutations of third party entities involved in the production, supply, distribution or sale of wine products and the variations within those products from each third party entity. Furthermore, as the characteristics of many consumable products are affected by climate, growth conditions or the like, the products characteristics may change over time, e.g. by year, leading to a further escalation in the number of preferred or optimized sets of control parameters received by the server 101. Consequently, the scale of the preferred or optimized sets of control parameters is such that a user of a wine decanter appliance 10 or similar consumable product processing appliance would have to expend considerable time in locating such information if it were not accessible in accordance with the method of the invention where such information is stored in a single network system and whereby, as will be explained below, the information can be automatically retrieved to a user's wine decanter appliance 10 with minimal effort by a user.

It will be understood that, whilst one thrust of the invention is to facilitate the uploading of preferred or optimized sets of control parameters to the server 101 by authorized third party entities, the third party entities 102 may be authorized to share other information relating to their products and to post advertisements and to make available product offers to users.

It will also be understood that the uploading of information is an ongoing process for the third party entities to maintain their product information and sets of control parameters current.

The control parameters for a wine product may comprise one or more oxygen concentration in the gas, pressure of the oxygen laden gas, temperature of the gas, and time dependent on the one or more of the identity, brand, grape type, quality and year of production.

A user of a wine decanter appliance 10 may manually input information through one or more of the various input interfaces 4, 5 identifying the wine product and/or one or more characteristics of said product.

In response to manually or automatically receiving product information, the appliance 10 automatically sends data relating to said information to the server 101. The server 101, upon receiving such data, processes it to retrieve the product information and to then retrieve a preferred or optimized set of control parameters for sending to the wine decanter appliance 10.

The step of manually inputting information relating to the wine product or automatically recognizing information relating to the wine product from the packaging or an image of the product may not occur entirely within the wine decanter appliance 10. In preferred embodiments, data relating to initial product information received at the wine decanter appliance 10 is automatically sent to the server 101 which processes the data to determine at least some of the product information which uniquely identifies the product and uses this to retrieve from the database 103 full product information which is then sent to the wine decanter appliance 10. The received full product information (including characteristics) is displayed to the user of the wine decanter appliance on the screen or display 5 and the user is invited to confirm said product information or make changes or corrections to it. In the event that the user makes changes, the step of identifying full product information may be repeated until the user confirms the displayed information. Once a user confirmation is received, the wine decanter appliance 10 automatically sends data comprising said confirmation to the server 101 which then retrieves the preferred or optimized set of control parameters for the identified wine product/characteristics.

The set of preferred or optimized control parameters received at the wine decanter appliance 10 may be used to automatically control the wine decanter appliance 10 using information retrieved by the server 101 or provided by other users over the social media network SN. Alternatively, the set of control parameters may be displayed to a user and the user invited to confirm the set of parameters or to make changes thereto prior to operation of the appliance 10 to oxidize wine. The set of control parameters, whether modified or not by the user, are stored in the memory of the wine decanter appliance 10. The set of control parameters, whether modified or not, may be stored in association with an identity of a user of the wine decanter appliance 10. This is desirable where a number of different users utilize the same wine decanter appliance 10 who each may have different preferences.

Where a set of control parameters, whether modified or not, is stored in the appliance 10 in association with a unique identity and/or some unique characteristics of the wine product, this set of control parameters can be retrieved from the data storage module 8 of the wine decanter appliance 10 when next the identified user or another user inputs or presents the same wine product information at the wine decanter appliance 10 thereby negating the need to contact the server 101 for a preferred or optimized set of control parameters for the wine product. Once again, the set of control parameters may be displayed to the user on the screen or display 5 for confirmation or modification. In the case where the subsequent user of the wine decanter appliance 10 is another user rather than the original user then any modifications made by said another user may be stored in the memory of the wine decanter appliance in association with said another user.

Where a user has modified a set of control parameters for a wine product, the user's modifications, changes or adjustments to the set of control parameters may be automatically communicated by the wine decanter appliance to the server 101 and/or to a third party entity device 102 where the third party entity is identified as being associated with the wine product. The wine decanter appliance 10 may also be configured to communicate such changes together with the wine product information to a selected user of another appliance 10 or to a selected group of other users where said selection of such other user or users is provided by the user of the wine decanter appliance 10 sending the information.

The third party entity may process users' changes to the sets of preferred or optimized parameters to change or update said sets of preferred or optimized parameters.

The server 101 may be configured to run analytical software to characterize users' changes and to publish its analysis of the changes to user appliances 10. Publication may be selectively targeted at those users known to have used a particular wine product. The server 101 may be configured to monitor social media message exchanges between users of the wine decanter appliances and to identify in said messages new or modified sets of control parameters for specific brands or types of wine and to make such information available to users of the wine decanter appliances. Such information may be made available when a user of an appliance uses their wine decanter appliance to process a certain brand or type of wine product whereby, the server on receiving information from the user's wine decanter appliance, publishes the new or modified information to the user, i.e. sends said information or a notification of the existence of said information to the user's appliance for display to the user on the screen 5 of the appliance.

The application program 2 executed by the central control unit 7 of the wine decanter appliance 10 is as already described as a social networking application which may be hosted by the server 101 which enables a user of said appliance 10 to exchange information through said communications network 100 with any one or any combination of: the server 101; a third party entity network device 102; another appliance 10; or a user selected subset of all network connected appliances 10. The social networking application also allows users of wine decanter appliance 10 to share other information with each other which may not be related to wine products, but the primary purpose of the social networking application is to facilitate a community having a shared interest in a particular consumable product and to share and have access to knowledge about said product in a manner which is easily accessible and efficient compared to other means of accessing information.

The wine decanter appliance 10 may be configured to seek a user's feedback after a user has used the appliance 10 to oxidize some wine. This may comprise receiving a user's rating information for the product to be consumed and to send said rating information to any one or any combination of: the server 101; a third party entity network device 102; another appliance 10; or a user selected subset of all network connected appliances 10. The server 101 may be configured to publish rating information for wine products and to display the (modified or updated) sets of control parameters for an identified wine product in order of greatest ratings. In this embodiment, the server 101 may communicate a list of best rated sets of control parameters to a wine decanter appliance 10 and send the set of control parameters in response to a user's selection of one from the list of best rated sets of control parameters for a specific product.

In another aspect of the invention, the data collected in the server 101 about users, their tastes and/or preferences may be provided under license, subscription or some other condition for use by the third party entities on improving their products, targeted marketing of their products, educating users on their products, or generally advertising their products. The server 101 may collect data about each user of a wine decanter appliance 10 charting their drinking habits, their product preferences, and/or their usage of the wine decanter appliance 10 and make this data available to third party entities for targeted marketing of their products, education about their products, providing users with recommended product packages or recommended product recipes or blends, or generally advertising their products. The server 101 may be configured to ‘sniff’ data about users' drinking habits, product preferences, and/or usage of the wine decanter appliance 10 from social media message exchanges between users and/or from other messages or requests sent by the users to the server 101. Where the server 101 is configured to host a shopping channel to enable users to purchase wine products, the server 101 again maintains data relating to the users' purchases as part of the data records for said users.

In another aspect of the invention, third party entities may be permitted to host any of their own: online workshops, chat rooms, blogs, forums, webinars, etc. concerning their products. Data collected from these activities is shared with the server 101 to enhance its data records for the users.

In general, the invention provides a method and a wine decanter appliance for automatically oxidizing wine. The wine decanter appliance comprises means for delivering a flow of oxygen laden gas to a quantity of wine to oxidize said wine, a communications module connecting said wine decanter appliance to a communications network, a memory storing an application program, and a processor configured to execute said application program to enable said wine decanter appliance to exchange information through said communications network with any one or any combination of: a server; a database; a network connected device, another wine decanter appliance or a group of other wine decanter appliances. The processor is configured to control said wine decanter appliance to oxidize the wine based on information received over said network as a consequence of said exchange of information.

1-25. (canceled)

26: A wine decanter appliance for oxidizing wine, comprising:
means for delivering a flow of oxygen laden gas to a quantity of wine to oxidize said wine;
a communications module connecting said wine decanter appliance to a communications network;
a memory storing an application program;
a processor configured to execute said application program to enable said wine decanter appliance to exchange information through said communications network with any one or any combination of: a server; a database; a network connected device, another wine decanter appliance or a group of other wine decanter appliances;
wherein said processor is configured to control said wine decanter appliance to oxidize the wine based on information received over said network as a consequence of said exchange of information.

27: The wine decanter appliance of claim 26, wherein the oxygen laden gas delivering means comprises:
an inlet for drawing in atmospheric air;
an air processing apparatus for concentrating oxygen in the drawn in air;
an outlet for delivering oxygen concentrated air under pressure to wine contained in a receptacle;

28: The wine decanter appliance of claim 26, wherein the processor is configured to control said wine decanter appliance to automatically oxidize the wine.

29: The wine decanter appliance claim 26, wherein said information received over said network as a consequence of said exchange of information comprises a set of control parameters for automatically controlling said wine decanter appliance to oxidize a wine.

30: The wine decanter appliance of claim 26, wherein said set of control parameters comprises instructions to control a minimum oxygen percentage of the oxygen laden gas.

31: The wine decanter appliance of claim 27, wherein the air processing apparatus comprises an oxygen concentrator apparatus adapted to remove some or most gases other than oxygen from atmospheric air to thereby provide oxygen concentrated air.

32: The wine decanter appliance of claim 31, wherein the oxygen concentrator apparatus comprises a molecular sieve adapted to remove some or most gases other than oxygen from atmospheric air to thereby provide oxygen concentrated air.

33: The wine decanter appliance of claim 26, further comprising:
a memory storing an application program; and
a processor configured to execute said application program to enable said wine decanter appliance to exchange information through said communications network with any one or any combination of: the server; the database; a network connected device, another wine decanter appliance or a group of other wine decanter appliances.

34: The wine decanter appliance of claim 33, wherein the application program executed by said processor is a social networking application which enables a user of said wine decanter appliance to exchange information through said communications network.

35: The wine decanter appliance of claim 34, wherein the wine decanter appliance is configured to retrieve the set of preconfigured control parameters from the server or database by:
receiving information identifying a wine to be oxidized and/or one or more characteristics of said wine at an input interface of the wine decanter appliance;
in response to receipt of said information at the wine decanter appliance, controlling the wine decanter appliance to automatically send data over said network to said server, said data comprising or relating to said received information; and
in response to sending data to the server, receiving the set of preconfigured control parameters from the server or database.

36: The wine decanter appliance of claim 35, wherein the information sent to the server comprises any one or any combination of: a type of the wine; a brand of the wine; a quality level of the wine; a year of production; and/or any other characteristic of the wine.

37: The wine decanter appliance of claim 34, wherein the wine decanter appliance comprises an input interface configured to receive information identifying the wine and/or one or more characteristics of said wine.

38: The wine decanter appliance of claim 37, wherein the input interface is configured to receive a user's changes, adjustments or modifications of any one or more of the parameters of a set of one or more parameters.

39: The wine decanter appliance of claim 38, wherein the processor is configured to store any user changes, adjustments or modifications to any one or more of the parameters of the set of parameters such that, when the same user uses the wine decanter appliance for processing a wine on a subsequent occasion, the wine decanter appliance implements the changed, adjusted or modified set of parameters.

40: The wine decanter appliance of claim 38, wherein the processor is configured to store said user changes, adjustments or modifications to any one or more of the set of parameters in association with: a type of the wine; a brand of the wine; a quality level of the wine; a year of production; and/or any other characteristic of the wine.

41: The wine decanter appliance of claim 38, wherein the processor is configured to store said user changes, adjustments or modifications to any one of the one or more of the set of parameters in association with a specified user of the wine decanter appliance

42: The wine decanter appliance of claim 38, wherein the wine decanter appliance is configured to send any user changes, adjustments or modifications to any one or more of the set of parameters to any one or any combination of: the server; a third party entity network device; another wine decanter appliance; or a user selected subset of all network connected wine decanter appliances.

43: The wine decanter appliance of claim 37, wherein the wine decanter appliance is configured to receive a user's rating information for the wine to be consumed where said wine is oxidized according to a set of parameters and to send said rating information to any one or any combination of: the server; a third party entity network device; another wine decanter appliance; or a user selected subset of all network connected wine decanter appliances.

44: A method of oxidizing wine in a network connected wine decanter appliance comprising the steps of:
connecting said wine decanter appliance to a communications network;
exchanging information through said communications network with any one or any combination of: a server; a database; a network connected device, another wine decanter appliance or a group of other wine decanter appliances for oxidizing wine;
controlling said wine decanter appliance to oxidize the wine based on information received over said network as a consequence of said exchange of information.

45: A computer readable medium storing machine readable instructions which, when implemented on a processor of a network connected wine decanter appliance, implements the steps of:
connecting said wine decanter appliance to a communications network;
exchanging information through said communications network with any one or any combination of: a server; a database; a network connected device, another wine decanter appliance or a group of other wine decanter appliances for oxidizing wine;
controlling said wine decanter appliance to oxidize the wine based on information received over said network as a consequence of said exchange of information.
